(19) United States
(12) Patent Application Publication
(10) Pub. No.: US 2009/0209668 A1
(43) Pub. Date: Aug. 20, 2009

(54) REINFORCED COMPOSITE MEMBRANE FOR POLYMER ELECTROLYTE FUEL CELL

(75) Inventors: Jong Hyun Lee, Gyeonggi-do (KR); Yoo Chang Yang, Gyeonggi-do (KR); Seung Chan Oh, Gyeonggi-do (KR); Jae Jun Ko, Gyeonggi-do (KR); Sang Mun Chin, Seoul (KR); Suk Kee Um, Daejeon (KR); Hye Mi Jung, Seoul (KR); Won Gyu Choi, Seoul (KR)

Correspondence Address: EDWARDS ANGELL PALMER & DODGE LLP, P.O. BOX 55874, BOSTON, MA, 02205, US

(73) Assignees: HYUNDAI MOTOR COMPANY, Seoul (KR); KOREA ADVANCED INSTITUTE OF SCIENCE AND TECHNOLOGY, Daejeon (KR)

(21) Appl. No.: 12/276,692

(22) Filed: Nov. 24, 2008

(30) Foreign Application Priority Data
Feb. 20, 2008 (KR) 10-2008-0015338

(51) Int. Cl. C08J 9/35

(52) U.S. Cl. 521/54

(57) ABSTRACT

The present invention relates to a method of manufacturing a proton-conducting reinforced composite membrane, and more particularly, to a reinforced composite membrane which is manufactured by introducing an additive into a sulfonated hydrocarbon-based polymer as a proton-conducting material, and impregnating the additive-introduced polymer into a porous polymer having excellent dimensional stability.

### CROSS-REFERENCE TO RELATED APPLICATION

This application claims the benefit under 35 U.S.C. §119(a) of Korean Patent Application No. 10-2008-0015338 filed on Feb. 20, 2008, the entire contents of which are incorporated herein by reference.

### BACKGROUND OF THE INVENTION

(a) Field of the Invention

The present invention relates to a method of manufacturing a proton-conducting reinforced composite membrane, and more particularly, to a reinforced composite membrane which is manufactured by introducing an additive into a sulfonated hydrocarbon-based polymer as a proton-conducting material, and impregnating the additive-introduced polymer into a porous polymer having considerable dimensional stability.

The manufactured reinforced composite membrane minimizes the thickness of a polymer electrolyte membrane to minimize cell resistance of the fuel cell and improve the dimensional stability so as to secure interface stability of the fuel cell to thereby enhance long-term performance of the fuel cell.

(b) Background Art

Currently, energy, such as crude oil, natural gas, or fossil fuels, and the effort to obtain these energy sources, affects the economy of many nations. However, these fossil energies are likely to be depleted in the future, and the interest of each country on alternative energy sources has been increasing due to this likely depletion, and the continued rise in oil prices, environmental pollution that occur with the use of fossil energy. Recent research has focused on hydrogen energy, which is a rich source on earth, enables a continuous supply and is environmentally-friendly among the alternative energies. Of particular interest related to hydrogen energy is a ‘fuel cell’.

A fuel cell is an electrochemical device that directly converts the chemical energy of hydrogen and oxygen into electrical energy, and continuously produces electricity by supplying hydrogen and oxygen to the anode and cathode electrodes.

With respect to the general properties of fuel cells, heat is also generated in a process of producing electricity by the electrochemical reaction of a fuel, making it possible to achieve high-efficiency electricity generation at a total efficiency of more than 80%, and the fuel cell has an efficiency higher than that of existing thermal power generation, thus making it possible to save fuel for electricity generation and to perform co-generation.

In addition, the fuel cell is a pollution-free energy technology, in which the emissions of nitrogen oxides and CO₂ are about 1/38 and ⅓, respectively, compared to those of coal burning thermal power generation, and the level of noise pollution is also very low, so that pollutants are not substantially discharged.

In addition, because fuel cell modules can be manufactured, the construction period of the fuel cell plant can be shortened, an increase or decrease in the equipment capacity of the fuel cell plant is possible, and the site selection of the fuel cell plant is easy. Thus, because the fuel cell can be placed in urban areas or buildings, it can supply energy in a cost effective way. Also, because the fuel cell can employ various fuels, including natural gas, city gas, naphtha, methanol and waste gases, it can replace existing thermal power generation and can be applied in power plants for distributed generation, co-generation power plants, power sources for pollution-free automobiles, and the like.

Recently, in order to address and solve environmental problems and the exhaustion of energy sources as well as in order to use fuel cell automobiles in practice, there has been an urgent need for the development of high-performance fuel cells, which have suitably high energy efficiency, can be operated at high temperatures and, at the same time, are reliable.

Fuel cells are largely classified into molten carbonate fuel cells (MCFCs) operating at high temperatures (500-700° C.), phosphoric acid fuel cells (PAFCs) operating at about 200° C., alkaline fuel cells (AFCs) operating in the range from room temperature to about 100° C., and polymer electrolyte membrane fuel cells.

Of these fuel cells, the polymer electrolyte membrane fuel cells are a future clean energy source capable of substituting for fossil energy and have high output density and energy conversion efficiency. Preferably, the polymer electrolyte membrane fuel cells can be operated at room temperature and can be miniaturized and closed, and thus they can be used in a wide range of applications, including pollution-free automobiles, residential power generation systems, mobile communication systems, medical devices, military equipment, and equipment for space applications.

The polymer exchange membrane fuel cell (PEMFC) is a power production system that produces direct current electricity from an electrochemical reaction of hydrogen with oxygen. The polymer exchange membrane fuel cell (PEMFC) has a structure in which a proton-conducting polymer membrane is interposed between an anode and a cathode. Preferably, the polymer exchange membrane fuel cell (PEMFC) comprises: a proton-conducting polymer membrane, which has a thickness of 50-200 μm and is preferably made of a solid polymer electrolyte; an anode and a cathode (hereinafter, the cathode and anode will be commonly referred to as “gas diffusion electrodes”), which comprise the respective support layers for the supply of reaction gas, and the respective catalyst layers in which oxidation/reduction reactions occur; and a carbon plate, which preferably has grooves for gas injection and suitably functions as a current collector. The catalyst layers in the gas diffusion electrodes of the polymer exchange membrane fuel cell (PEMFC) are formed on the support layers, respectively, in which the support layers are made of carbon cloth or carbon paper, and the surfaces thereof are treated such that reaction gas, water, which is transferred to the proton-conducting polymer membrane, and water resulting from the reactions, are easily passed.

In polymer exchange membrane fuel cell (PEMFC) having the above-described structure, hydrogen as the reaction gas is suitably supplied to the anode while an oxidation reaction occurs in the anode to convert hydrogen molecules to hydrogen ions and electrons, and the converted hydrogen ions are transferred to the cathode through the proton-conducting polymer membrane. In the cathode, a reduction reaction, in which oxygen molecules are converted into oxygen ions by receiving electrons, occurs, and the produced oxygen ions are converted to water molecules by reacting with the hydrogen ions transferred from the anode.

Such polymer electrolyte membrane fuel cells can be classified into proton exchange membrane fuel cell (PEMFCs), which preferably use hydrogen gas as a fuel, and direct methanol fuel cells (DMFCs), which preferably use liquid methanol, supplied directly to the anode, as a fuel.

Preferably, the proton-conducting polymer membrane functions to transfer protons produced on the anode to the cathode. In order to obtain a high output (i.e., high current density) in PEMFC, the conduction of protons needs to be performed in a suitably sufficient amount at a high rate. Accordingly, the performance of the proton-conducting polymer membrane is important in determining the performance of PEMFC. In addition, the proton-conducting membrane acts to conduct protons as well as function as an insulating film to electrically insulate the anode and the cathode from each other. The proton-conducting membrane also suitably functions as a fuel barrier film for preventing fuel supplied into the anode from leaking to the cathode.

A proton-conducting membrane which is generally used in PEFC at present is a fluororesin-based membrane having a perfluoroalkylene as a main skeleton and partly having a sulfuric acid group at the end of perfluorovinylether side chain. Known examples of such sulfonated fluororesin-based membranes include NAFION (trade name) (produced by E.I. Dupont de Nemours), FLEMION (trade name) film (produced by Asahi Glass KK), ACIPLEX (trade name) film (produced by Asahi Chemical Industry Co.), etc.

Currently, the most common material preferably used as an electrolyte membrane of the polymer electrolyte fuel cell is a perfluorinated polymer-based Nafion which is excellent in hydrolysis stability and proton conductivity.

However, Nafion is high in cost, is less favorable in dimensional stability, exhibits a reduction in proton conductivity at high temperature (more than 80° C.), and is high in fuel permeability, which makes it difficult to be put to practical use.

These fluororesin-based membranes are said to have a glass transition temperature (Tg) in the vicinity of 130° C. under wet conditions where the fuel cell is used. At this temperature, so-called creep occurs. As a result, the protonic conduction structure in the membrane changes, making it difficult to attain stable protonic conduction performance. Furthermore, the membrane is denatured to a swollen state which, after prolonged exposure to high temperature, becomes jelly-like and thus can easily break, leading to failure of the fuel cell. For the aforementioned reasons, the current highest temperature at which the fuel cell can be used stably over an extended period of time is normally 80° C.

A fuel cell employs chemical reaction in principle, and thus exhibits a higher energy efficiency when operated at higher temperatures. Accordingly, as viewed on the basis of the same electricity output, a device which can be operated at higher temperatures can be reduced more in size and weight. Preferably, when the fuel cell is operated at high temperatures, its waste heat can also be utilized, allowing cogeneration (combined supply of heat and electricity) that considerably enhances the total energy efficiency. Accordingly, it is considered that the operating temperature of a fuel cell is somewhat high, normally 100° C. or more, particularly preferably 120° C. or more (Korean Patent Registration No. 10-0701549).

When the polymer electrolyte fuel cell is operated at temperatures higher than 100° C., the activity of the electrode catalyst and the reaction rate of the electrode can suitably increase, and thus the fuel cell performance can be improved with a reduced amount of the catalyst. Also, a decrease in the amount of use of an expensive platinum catalyst can lead to a decrease in the cost of the fuel cell system. Furthermore, a few ppm of hydrocarbon contained in reformed hydrogen fuel is oxidized to carbon monoxide by a catalytic reaction on the electrode surface, and the generated carbon monoxide is adsorbed on the surface of the platinum catalyst to poison the catalyst. The adsorption of carbon monoxide onto the catalyst is an exothermic reaction, and thus when the fuel cell is operated at high temperatures, the performance of the fuel cell can be stably improved, because catalyst poisoning can be suitably reduced, even when reformed hydrogen gas containing a small amount of hydrocarbon is used. Preferably, when the fuel cell can be operated without external pressurization, an external pressurizing device and humidifying device becomes simple or unnecessary, thus optimizing the entire system and costs.

Direct fuel cells (e.g., DMFC) directly use fuels other than hydrogen. Various studies have focused on efficiently extracting protons and electrons from fuels. However, the improvement in the fuel barrier property of the proton-conducting polymer membrane, and operation at a high temperature at which a catalyst effectively functions, are considered to be important to obtain a sufficient output.

Thus, although it is considered desirable from various standpoints of view that PEFC is operated at higher temperatures, the heat resistance of the proton-conducting membrane is up to 80° C. as previously mentioned and the operating temperature of the fuel cell, too, is thus limited to 80° C. at present.

The reaction that occurs during the operation of a fuel cell is an exothermic reaction, and when a fuel cell is operated, the temperature in PEFC rises spontaneously. However, since Nafion, which is a representative proton-conducting membrane that is used at present, has only heat resistance up to about 80° C., it is necessary that PEMFC be cooled so that the temperature does not reach 80° C. or more. Cooling is normally carried out by a water cooling method, and so the separator portion of PEFC has been devised for such cooling. Accordingly, when such a cooling unit is employed, the entire system of the PEMFC has an increased size and weight, making it considerably difficult to make sufficient use of the original characteristics of PEFC, which are its small size and light weight.

In particular, when the limit of operation temperature is 80° C., a water cooling system, which is the simplest cooling system, can have difficulty with effectively cooling the system. If operation at 100° C. or more is carried out, effective cooling occurs by releasing the evaporation heat of water, and when water is circulated, the amount of water to be used in cooling can be considerably reduced, thus making it possible to attain a suitable reduction of size and weight of the device. In particular, in a case where PEMFC is used as an energy source for vehicles, a comparison of a preferred system involving the temperature control to 80° C. with a preferred system involving the temperature control to 100° C. or more shows that the volume of radiator and cooling water can be considerably reduced. Further, it would be preferred to provide PEMFC which can operate at 100° C. or more, i.e., a proton-conducting membrane having a heat resistance of 100° C. or more.

Accordingly, in order to replace perfluorinated polymer-based Nafion, research is on going for a novel hydrocarbon-based proton-conducting material preferably having a relatively low fuel permeability while being usable at high temperature. A representative example of the proton-conducting material includes, but is not limited to, polyetheretherketone, polyethersulfone, polyimide, etc.

The alternative polymer electrolyte membrane having a suitably low fuel permeability is also high in water content during the hydrolysis, resulting in degradation of dimensional stability as well as making it difficult to implement performance of the polymer electrolyte fuel cell due to a decrease in mechanical properties. Thus, in order to obtain the improved cell performance, there is a need for the development of a new material which has considerable dimensional stability and mechanical properties according to hydrolysis of these alternative polymer electrolyte membranes.

U.S. Pat. No. 5,547,551 is directed to a Nafion ionomer as a proton-conducting material that is introduced into e-PTFE to improve the dimensional stability of the polymer membrane; however a decrease in proton conductivity at a temperature of more than 80 C of Nafion is still shown. Korean Patent Registration No. 10-0746339 is directed to a membrane that exhibits an improved dimensional stability as compared to the existing sulfonated hydrocarbon-based proton-conducting polymer membrane, but the thickness of the membrane needs to be minimized so as to be applied as a membrane for PEMFC. Accordingly, there is an urgent need for the development of a material having considerable proton conductivity and dimensional stability at a temperature of more than 80° C. through the manufacture of a thin membrane based on a sulfonated hydrocarbon-based proton-conducting polymer material.

The information disclosed in this Background of the Invention section is only for enhancement of understanding of the background of the invention and should not be taken as an acknowledgment or any form of suggestion that this information forms the prior art that is already known to a person skilled in the art.

### SUMMARY OF THE INVENTION

The present invention is directed to a proton-conducting reinforced composite membrane for a polymer electrolyte fuel cell and method of manufacturing the same. More particularly, the present invention is directed to a reinforced composite membrane which is completed by employing a sulfonated hydrocarbon-based polymer as a proton-conducting material, and impregnating the sulfonated hydrocarbon-based polymer into a porous polymer having considerable dimensional stability, a forming material thereof, and a method of manufacturing the reinforced composite membrane and the forming material.

It is an object of the present invention to suitably improve the performance of a fuel cell based on interface stability achieved by minimizing the thickness of a polymer electrolyte membrane through the manufactured reinforced composite membrane to minimize cell resistance and improving dimensional stability of the polymer electrolyte membrane.

In one aspect, the present invention is directed to a proton-conducting reinforced composite membrane. In preferred embodiments, the present invention is direct to a proton-conducting reinforced composite membrane preferably manufactured by introducing a suitable additive as monomers alone or as a polymer blend of a mixture of two or more selected from the group consisting of, but not limited to, vinylidene fluoride, hexafluoropropylene, trifluoroethylene and tetrafluoroethylene into a sulfonated hydrocarbon-based polymer composite material, and impregnating the additive-introduced polymer composite material into a porous polymer matrix.

In other preferred embodiments, the present invention is characterized in that the porous polymer matrix is one or a mixture of two or more selected from the group consisting of, but not limited to, polysulfone, polyaryleneethersulfone, polyetherethersulfone, polyethersulfone, polyimide, polyimidazole, polybenziimidazole, polyetherbenziimidazole, polyaryleneetherketone, polyetheretherketone, polyetherketone, polyetherketoneketone, polystyrene and polytetrafluorethylene.

According to the proton-conducting reinforced composite membrane for the polymer electrolyte fuel cell of the present invention, the hydrocarbon-based proton-conducting polymer electrolyte is preferably introduced into the porous polymer having considerable dimensional stability to thereby obtain considerable proton conductivity and dimensional stability.

In other preferred embodiments, the proton-conducting reinforced composite membrane for the polymer electrolyte fuel cell of the present invention suitably employs a hydrocarbon-based porous polymer support preferably having a considerably low water content so as to suitably maintain the intrinsic mechanical properties of the hydrocarbon-based polymer even during the hydrolysis to thereby considerably improve the mechanical properties of the reinforced composite membrane which has been substantially completely or completely hydrolyzed.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum).

As referred to herein, a hybrid vehicle is a vehicle that has two or more sources of power, for example both gasoline-powered and electric-powered.

The above features and advantages of the present invention will be apparent from or are set forth in more detail in the accompanying drawings, which are incorporated in and form a part of this specification, and the following Detailed Description, which together serve to explain by way of example the principles of the present invention.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a cross-sectional view showing a reinforced composite membrane manufactured in Example 1; and

FIG. 2 is a graph showing the relationship between proton conductivity and temperature of the reinforced composite membranes manufactured in Examples 1 and 2.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

### DETAILED DESCRIPTION

In one aspect, the invention features a proton-conducting reinforced composite membrane manufactured by the method comprising introducing an additive as monomers alone or a polymer blend into a hydrocarbon-based polymer composite material, impregnating the additive-introduced polymer composite material into a porous polymer matrix.

In one embodiment of the invention as described herein, the proton-conducting reinforced composite membrane is a mixture of two or more polymers.

In another embodiment, the monomer or polymer blend is selected from the group consisting of, but not limited to, vinylidene fluoride, hexafluoropropylene, trifluoroethylene and tetrafluoroethylene.

In another embodiment of the aspect of the invention as described herein, the hydrocarbon-based polymer composite material is a sulfonated hydrocarbon-based polymer composite material. In another related embodiment, the additive is used in an amount of 0.1 to 50 wt % based on the total weight of the hydrocarbon-based polymer.

In other preferred aspects, the invention features a vehicle that comprises the proton-conducting reinforced composite membrane manufactured by the method described by the aspects described herein.

Reference will now be made in detail to the preferred embodiments of the present invention, examples of which are illustrated in the drawings attached hereinafter, wherein like reference numerals refer to like elements throughout. The embodiments are described below so as to explain the present invention by referring to the figures.

A fuel cell vehicle has advantages over a gasoline vehicle or a hybrid vehicle in terms of fuel efficiency, convenience of fuel supply, stillness, etc. The fuel cell vehicle is an environmentally-friendly vehicle which is free of exhaust emission except water, and utilizes a polymer electrolyte fuel cell that mainly employ hydrogen. The fuel cell vehicle is driven with electricity produced by the fuel cell. Accordingly, a polymer electrolyte fuel cell employing hydrogen does not have environment-destroying effects due to the emission of harmful materials when fossil fuels, for example, petroleum, are burnt. Further, when a polymer electrolyte fuel cell that employs hydrogen is used, the concern about the depletion of energy is lessened.

A polymer electrolyte fuel cell varies in efficiency depending on the characteristics of a polymer electrolyte membrane. Therefore, in order to obtain an improved fuel cell performance, a material is needed which is has suitable dimensional stability and mechanical properties as well as demonstrating suitable proton conductivity even at high temperature.

In preferred embodiments, the present invention is directed to a proton-conducting reinforced composite membrane and will be described hereinafter.

The present invention is directed to a proton-conducting reinforced composite membrane suitably manufactured by introducing an additive as monomers alone or a polymer blend of a mixture of two or more selected from the group consisting of, but not limited to, vinylidene fluoride, hexafluoropropylene, trifluoroethylene and tetrafluoroethylene into a hydrocarbon-based polymer composite material, preferably a sulfonated hydrocarbon-based polymer composite material, and suitably impregnating the additive-introduced polymer composite material into a porous polymer matrix.

In preferred embodiments, the additive is preferably used in an amount of 0.1 to 50 wt % based on the total weight of the sulfonated hydrocarbon-based polymer.

According to preferred embodiments of the invention as described, a material produced by mixing, preferably mechanically mixing, two or more polymers with each other is called a “polymer blend”. Many polymer blends exhibit suitably different properties from each individual polymer, and the merits and demerits of individual polymer are mutually complemented and enhanced.

In other preferred embodiments, the additive refers to a chemical substance which is preferably added in the course of processing or polymerization so as to facilitate the processing of the polymer or synthetic resin as well as suitably complement or improve these products. For example, the improvement may preferably be an improvement of the chemical or physical properties or improvement of processability depending on function, or any combination of all of the aforementioned. In preferred embodiments, additives are classified into plasticizers, antioxidants, heat stabilizers, UV stabilizers, flame retardents, lubricants, antistatic agents, foaming or blowing agents, impact modifiers, fillers, crosslinking agents, colorants, antifogging agents, nucleating agents, antiblocking and slip agents, etc. Currently, the applicable range of additives has been much expanded going beyond the literal meaning of a simple auxiliary material. Additives are recognized as an indispensable core material having a deterministic effect on the final performance of the polymer, and its function is diversified. Any additive known in the art useful in the method as claimed is suitable for use in the present invention.

In exemplary embodiments, an additive is introduced into the sulfonated hydrocarbon-based polymer material. Preferred examples of the additive applicable to a polymer material having excellent dimensional stability includes monomers alone or a polymer blend of a mixture of two or more selected from the group consisting of, but not limited to, vinylidene fluoride, hexafluoropropylene, trifluoroethylene and tetrafluoroethylene. In examples where the reinforced composite membrane in which the additive is not introduced, there is an interface separation between the membrane and the electrodes. However, preferably, as seen in the preferred embodiments of the invention as described herein, in the reinforced composite membrane in which the additive is introduced, interface stability is suitably improved between the membrane and the electrodes to suitably prevent occurrence of the interface separation between the membrane and the electrodes.

In further preferred embodiments, the molecular weight of the polymer materials is preferably selected from a number-average molecular weight of 1,000 to 1,000,000 and a weight-average molecular weight of 10,000 to 1,000,000.

In other preferred embodiments, the polymer material as the additive introduced into the sulfonated hydrocarbon-based polymer material is preferably added in an amount of 0.01 to 50 wt %, preferably 0.1 to 20 wt %, most preferably 1 to 10 wt % based on the total weight of the sulfonated hydrocarbon-based polymer. Preferably, if the polymer material is added in an amount of 50wt % or more based on the total weight of the sulfonated hydrocarbon-based polymer, phase separation may suitably occur between the polymers and proton conductivity of the polymer electrolyte may be suitably decreased. In other embodiments, if the polymer material is added in an amount of 0.01 wt % or less based on the total weight of the sulfonated hydrocarbon-based polymer, dimensional stability of the of the polymer electrolyte may be suitably degraded.

According to preferred embodiments the present invention is characterized in that the hydrocarbon-based polymer is sulfonated.

Sulfuric acid is an organic acid containing sulfur and its chemical formula is represented by sRSO₃H (where R represents an organic atomic group). Sulfuric acid has considerable importance among the organic sulfur compounds, and is widely used as a catalyst inorganic synthesis reactions, and salt and other derivatives are used to produce phenolic compounds, detergents, water-soluble dyes, sulfonamide-based drugs and ion-exchange resins. An aromatic sulfuric acid is an important organic acid used as an intermediate or a starting material in the organic synthesis reaction. Aromatic sulfuric acid is typically obtained by a reaction of an aromatic compound and a thick sulfuric acid, which is called “sulfonation reaction”.

In preferred embodiments, examples of a suitable sulfonated hydrocarbon-based polymer material may be obtained by sulfonating one or a mixture of two or more selected from the group consisting of, but not limited to, polysulfone, polyaryleneethersulfone, polyetherethersulfone, polyethersulfone, polyimide, polyimidazole, polybenziimidazole, polyetherbenziimidazole, polyaryleneetherketone, polyetheretherketone, polyetherketone, polyetherketoneketone and polystyrene. Preferably, the sulfonated hydrocarbon-based polymer has a sulfonation degree of preferably 10 to 80%, more preferably 20 to 70%, most preferably 30 to 60%. In preferred embodiments, if the sulfonation degree is less than 10%, ion conductivity is suitably decreased, and if the sulfonation degree is more than 80%, the physical properties are suitably degraded. In other further embodiments, the sulfonated hydrocarbon-based polymer is preferably selected from polymers having a number-average molecular weight of 1,000 to 1,000,000 and a weight-average molecular weight of 10,000 to 1,000,000.

In exemplary embodiments of the invention described herein the porous polymer matrix uses a porous membrane manufactured from one or a mixture of two or more selected from the group consisting of, but not limited to, polysulfone, polyaryleneethersulfone, polyetherethersulfone, polyethersulfone, polyimide, polyimidazole, polybenziimidazole, polyetherbenziimidazole, polyaryleneetherketone, polyetheretherketone, polyetherketone, polyetherketoneketone, polystyrene, polytetrafluorethylene, polyethylene and polyprophylen, preferably polyimide. The porous polymer material is not limited to the examples.

Preferably, a porous material refers to a material having regular pores formed therein, and is generally widely applied in a separating membrane, a catalyst, an adsorbing agent or the like. Preferably, the size of each of pore inside the porous polymer membrane ranges from 0.001 to 1000 μm, more preferably 0.001 to 100 μm, and most preferably 0.001 to 10 μm. Preferably, if the size of each pore is less than 0.001 μm, impregnation is not easy. Preferably, if the size of each pore is more than 1000 μm, the physical properties of the polymer membrane is suitably degraded. In further embodiments, a Gurley number indicating air permeability of the porous polymer is preferably selected from 1 to 10,000, more preferably 10 to 5,000, and most preferably 100 to 1,000.

Further, the thickness of the porous polymer membrane preferably ranges from 0.1 to 1000 μm, more preferably from 0.1 to 100 μm, most preferably from 0.1 to 50 μm. The porous polymer membrane is made thin to reduce a membrane resistance to thereby improve the cell performance. Thus, it is preferable to make the porous polymer membrane as thin as possible.

The porous polymer membrane as described above has 0.001 to 50% of water content, more preferably 0.01 to 10%, and most preferably 0.1 to 1%. If the water content of porous polymer membrane is less than 0.001%, ion conductivity is decreased. Meanwhile, if the water content of porous polymer membrane is more than 50%, dimensional stability is sharply degraded.

The porous polymer functions as a support of the electrolyte membrane, and has an effect on thermal stability, rate of dimensional change and water content of the electrolyte membrane depending on intrinsic physical properties of each porous polymer. The porous polymer matrix is one or a mixture of two or more selected from the group consisting of polysulfone, polyaryleneethersulfone, polyetherethersulfone, polyethersulfone, polyimide, polyimidazole, polybenziimidazole, polyetherbenziimidazole, polyaryleneetherketone, polyetheretherketone, polyetherketone, polyetherketoneketone, polystyrene, polytetrafluorethylene, polyethylene and polyprophylen, preferably polyimide.

When polyimide is used as the porous polymer matrix, proton conductivity and thermal stability are more excellent at high temperature as compared to when the typically used e-PTFE (e-polytetrafluorethylene, expanded PTFE) is used.

In further embodiments, the hydrocarbon-based polymer can react with a thick sulfuric acid to obtain a sulfonated hydrocarbon-based polymer. The additive uses monomers alone selected from the group consisting of vinylidene fluoride, hexafluoropropylene, trifluoroethylene and tetrafluoroethylene, or a polymer blend. Preferably, the additive is added to a solvent together with the hydrocarbon-based polymer and is introduced into the hydrocarbon-based polymer to thereby produce a polymer composite solution. In further preferred embodiments, a porous polymer matrix manufactured with a thin membrane is impregnated with the polymer composite solution to thereby manufacture a proton-conducting reinforced composite membrane.

Preferably, the additive is used in an amount of 0.1 to 50 wt % based on the total weight of the sulfonated hydrocarbon-based polymer.

In certain preferred embodiments, the hydrocarbon-based polymer is one or a mixture of two or more selected from the group consisting of, but not limited to, polysulfone, polyaryleneethersulfone, polyetherethersulfone, polyethersulfone, polyimide, polyimidazole, polybenziimidazole, polyetherbenziimidazole, polyaryleneetherketone, polyetheretherketone, polyetherketone, polyetherketoneketone and polystyrene.

In further embodiments, the hydrocarbon-based polymer preferably has a sulfonation degree of 10 to 80%.

In certain preferred embodiments, the porous polymer matrix is one or a mixture of two or more selected from the group consisting of, but not limited only to, polysulfone, polyaryleneethersulfone, polyetherethersulfone, polyethersulfone, polyimide, polyimidazole, polybenziimidazole, polyetherbenziimidazole, polyaryleneetherketone, polyetheretherketone, polyetherketone, polyetherketoneketone, polystyrene, polytetrafluorethylene, polyethylene and polyprophylen. In other embodiments, the porous polymer matrix is preferably polyimide.

In order to provide a more thorough understanding of the present invention, the present invention will be described hereinafter in further detail with reference to preferred examples in which the manufacturing process is more specified. These examples are merely presented to understand the content of the present invention, but the scope of the present invention should not be construed as being limited to these examples.

### EXAMPLES

### Example 1

### Manufacture of Reinforced Composite Membrane by Impregnation of Porous Polyimide Polymer

Polyetheretherketone was sulfonated in a thick sulfuric acid solution. 500 ml of 98% thick sulfuric acid was added into a round bottom flask with a volume of 100 ml and nitrogen was purged into the flask. Thereafter, 29 g of polyetheretherketone polymer vacuum-dried at 100° C. for 24 hrs was added to the nitrogen-purged solution and was intensively stirred at 50° C. The sulfonated reactant was precipitated in distilled water for 12 hrs and was then filtered and recovered. The recovered reactant was washed several times so that its acidity is neutralized to pH 6-7, and was re-recovered through filtration. The re-recovered reactant was vacuum-dried at 100° C. for 24 hrs to thereby prepare a sulfonated polyetheretherketone polymer.

2.5 wt % of polyvinylidenefluoride based on the total weight of the above prepared sulfonated polyetheretherketone polymer was dissolved in a solvent (N-Methyl Pyrolidone, NMP) together with the sulfonated polyetheretherketone polymer to prepare 1 wt %, 3 wt % and 5 wt % of homogeneous mixed solutions by concentration, respectively.

A porous polyimide membrane (the size of each pore is 1 μm) having a thickness of 25 μm was impregnated with 1 wt % of the above prepared polymer electrolyte mixed solution. After impregnation, a vacuum state was maintained for 1 hr. Thereafter, the impregnated porous membrane was picked out from the mixed solution and was then dried in a vacuum oven at 140° C. for 10 min. Then, the dried porous membrane was re-impregnated with 3 wt % of mixed solution and was maintained in al vacuum state for 10 min. Thereafter, the re-impregnated porous membrane was picked out from the mixed solution and was re-dried in a vacuum oven at 140° C. for 10 min to thereby prepare a re-dried porous membrane. The re-dried porous membrane was coated in 5 wt % of mixed solution. The coated porous membrane was completely dried in a vacuum oven at 140° C. for 1 hr.

The completely dried porous membrane was immersed for 30 min in 3 wt % of hydrogen peroxide solution kept at 60° C., and was then washed with distilled water. Then, the washed porous membrane was again immersed for 2 hrs in sulfuric acid solution having a concentration of 0.5M kept at 60° C. Thereafter, the porous membrane was picked out from the sulfuric acid solution and was washed with distilled water. The porous membrane was left to stand for 1 hr in distilled water at 60° C. The completed membrane was stored in distilled water of room temperature.

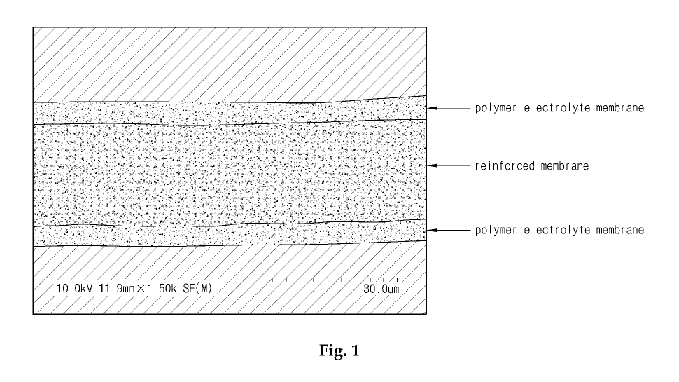

FIG. 1 is a cross-sectional view showing a reinforced composite membrane manufactured in Example 1.

As shown in FIG. 1, sulfonated polyetherketone and polyvinylidene fluoride were homogeneously impregnated into the porous polyimide polymer to thereby manufacture a relatively homogeneous reinforced composite membrane.

### Example 2

### Manufacture of Reinforced Composite Membrane by Impregnation of Porous Polytetrafluorethylene Polymer

Instead of the porous polyimide polymer membrane, a porous polytetrafluorethylene polymer membrane was introduced and the reinforced composite membrane was manufactured using the same component and composition as in Example 1 and using the same method as in Example 1.

### Comparative Example 1

### Manufacture of Polymer Composite Membrane Into Which a Porous Polymer is not Introduced

2.5 wt % of polyvinylidenefluoride based on the total weight of the above prepared sulfonated polyetheretherketone polymer was dissolved in a solvent (N-Methyl Pyrolidone, NMP) together with the sulfonated polyetheretherketone polymer to thereby prepare 10 wt % of homogeneous mixed solution. The above prepared mixed solution was cast using a doctor blade process on a glass plate. The cast mixed solution was dried at an oven at 50° C. for 24 hrs, and was re-dried at a vacuum oven at 140° C. for 24 hrs. Then, the dried cast product was impregnated with distilled water to obtain a proton-conducting polymer composite membrane. The proton-conducting polymer composite membrane was again dried at the vacuum oven at 50° C. for 24 hrs to finally obtain a sulfonated polyetheretherketone polymer electrolyte membrane. The finally obtained polymer electrolyte membrane was stored in distilled water.

A porous polyimide membrane (the size of each pore is 1 μm) having a thickness of 25 μm was impregnated with 1 wt % of the above prepared polymer electrolyte mixed solution. After impregnation, a vacuum state was maintained for 1 hr. The impregnated porous membrane was picked out from the mixed solution and was then dried in a vacuum oven at 140° C. for 10 min. Then, the dried porous membrane was re-impregnated with 3 wt % of mixed solution and was maintained in al vacuum state for 10 min. The re-impregnated porous membrane was picked out from the mixed solution and was re-dried in a vacuum oven at 140° C. for 10 min to thereby prepare a re-dried porous membrane. The re-dried porous membrane was coated in 5 wt % of mixed solution. The coated porous membrane was completely dried in a vacuum oven at 140° C. for 1 hr.

### Comparative Example 2

### Manufacture of Polymer Composite Membrane Into Which an Additive is not Introduced

The reinforced composite membrane was manufactured using the same component and composition as in Example 1 and the same method as in Example 1 without any introduction of a polymer blend additive.

### Test Example 1

### Measurement of Proton Conductivity According to Temperature

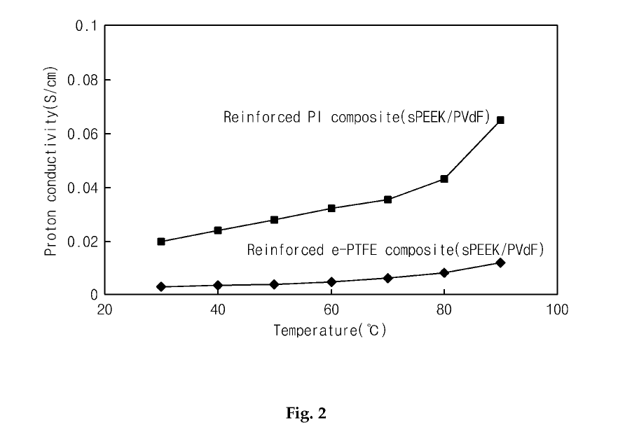

The proton conductivity of the polymer electrolyte membrane prepared in the above Examples 1 and 2 and Comparative Example 1 was measured using a frequency response analyzer (FRA) and its measurement result was shown in a graph of FIG. 2.

FIG. 2 shows the relationship between proton conductivity and temperature of the reinforced composite membranes. An impedance measurement condition was set forth such that a frequency was set within a range between 1 Hz and 1 MHz for the measurement of impedance. The measurement of the proton conductivity was carried out in an in-plane manner and all the tests were conducted in a state where the sample was substantially completely or completely impregnated.

It can be seen from the test result of FIG. 2 that the value of the proton conductivity of the porous polyimide composite membrane into which the proton-conducting polymer material was impregnated showed a similar value to that of an existing sPEEK/PVdF blend membrane.

### Test Example 2

### Measurement of Water Content According to Examples

TABLE 1

| | | | Example 2- | Comparative |
|---|---|---|---|---|
| | | Example 1- | reinforced | Example 1- |
| | | reinforced | composite | polymer |
| | | composite | membrane | electrolyte |
| | | membrane | (Reinforced | membrane |
| | | (Reinforced PI | e-PTFE | (sPEEK/ |
| | | membrane with | membrane with | PVdF blend |
| Properties | | sPEEK/PVdF) | sPEEK/PVdF) | membrane) |
| Water content (%) | | 15 | 13 | 32 |
| Rate of | Length | 11 | 10 | 15 |
| dimensional | | | | |
| change (%) | | | | |
| Rate of | Thickness | 4 | 3 | 13 |
| dimensional | | | | |
| change (%) | | | | |

The water content of the polymer electrolyte membrane prepared in the above Examples 1 and 2 and Comparative Example 1 was measured based on the ratio of weight change before and after hydrolysis and its measurement result was shown in the above Table 1. It can be seen from the result of the above Table 1 that the water content of the reinforced composite membrane was relatively greatly reduced as compared to the composite membrane in which polyvinylidenefluoride was introduced into the sulfonated polymer.

### Test Example 3

### Measurement of the Rate of Dimensional Change According to Examples

The dimensional stability of the polymer electrolyte membrane prepared in the above Examples 1 and 2 and Comparative Example 1 was measured using a dimensional rate before and after hydrolysis and its measurement result was shown in the above Table 1. It can be seen from the results shown in Table 1, above, that thereinforced composite membrane was considerably improved in terms of dimensional stability as compared to the composite membrane in which polyvinylidenefluoride was introduced into the sulfonated polymer.

### Test Example 4

### Measurement of Interface Separation According to Introduction of Additive

In case where the porous composite membrane of Comparative Example 2 in which the additive is not introduced, it was found that when the porous composite membrane was operated for a given time period after the manufacture of MEA, an interface separation occurred between the membrane and the electrodes. On the contrary, as seen in Examples 1 and 2, substantially no interface separation was observed between the membrane and the electrodes. A reason for this may be that, as seen in Comparative Example 2, a fluorine-based inomer and hydrocarbon-based polymer electrolyte membrane is weak in adhesion, and hence an interface separation occurred between the membrane and the electrodes the membrane due to volume expansion of the membrane during the hydrolysis.

As described above, according to the proton-conducting reinforced composite membrane for the polymer electrolyte fuel cell of the present invention, the hydrocarbon-based proton-conducting polymer electrolyte is introduced into the porous polymer having considerable dimensional stability to thereby obtain considerable proton conductivity and dimensional stability.

further, the proton-conducting reinforced composite membrane for the polymer electrolyte fuel cell of the present invention preferably employs a hydrocarbon-based porous polymer support having a suitably low water content so as to maintain the intrinsic mechanical properties of the hydrocarbon-based polymer even during the hydrolysis to thereby considerably improve the mechanical properties of the reinforced composite membrane which has been completely hydrolyzed.

The invention has been described in detain with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A proton-conducting reinforced composite membrane manufactured by introducing an additive as monomers alone or a polymer blend of a mixture of two or more selected from the group consisting of vinylidene fluoride, hexafluoropropylene, trifluoroethylene and tetrafluoroethylene, into a sulfonated hydrocarbon-based polymer composite material, and impregnating the additive-introduced polymer composite material into a porous polymer matrix.

2. The proton-conducting reinforced composite membrane of claim 1, wherein the additive is used in an amount of 0.1 to 50 wt % based on the total weight of the sulfonated hydrocarbon-based polymer.

3. The proton-conducting reinforced composite membrane of claim 1, wherein the hydrocarbon-based polymer is one or a mixture of two or more selected from the group consisting of polysulfone, polyaryleneethersulfone, polyetherethersulfone, polyethersulfone, polyimide, polyimidazole, polybenziimidazole, polyetherbenziimidazole, polyaryleneetherketone, polyetheretherketone, polyetherketone, polyetherketoneketone and polystyrene.

4. The proton-conducting reinforced composite membrane of claim 3, wherein the hydrocarbon-based polymer has a sulfonation degree of 10 to 80%.

5. The proton-conducting reinforced composite membrane of claim 1, wherein the porous polymer matrix is one or a mixture of two or more selected from the group consisting of polysulfone, polyaryleneethersulfone, polyetherethersulfone, polyethersulfone, polyimide, polyimidazole, polybenziimidazole, polyetherbenziimidazole, polyaryleneetherketone, polyetheretherketone, polyetherketone, polyetherketoneketone, polystyrene, polytetrafluorethylene, polyethylene and polyprophylen, preferably polyimide.

6. The proton-conducting reinforced composite membrane of claim 5, wherein the size of each of pores inside the porous polymer matrix ranges from 0.001 to 1000 μm, and the pores are linked to each other.

7. The proton-conducting reinforced composite membrane of claim 5, wherein the porous polymer matrix has 0.001 to 50% of water content.

8. A proton-conducting reinforced composite membrane manufactured by the method comprising:
introducing an additive as monomers alone or a polymer blend into a hydrocarbon-based polymer composite material;
impregnating the additive-introduced polymer composite material into a porous polymer matrix.

9. The proton-conducting reinforced composite membrane manufactured by the method of claim 8, wherein the polymer blend is a mixture of two or more polymers.

10. The proton-conducting reinforced composite membrane manufactured by the method of claim 8, wherein the monomer or polymer blend is selected from the group consisting of: vinylidene fluoride, hexafluoropropylene, trifluoroethylene and tetrafluoroethylene.

11. The proton-conducting reinforced composite membrane manufactured by the method of claim 8, wherein the hydrocarbon-based polymer composite material is a sulfonated hydrocarbon-based polymer composite material.

12. The proton-conducting reinforced composite membrane of claim 1, wherein the additive is used in an amount of 0.1 to 50 wt % based on the total weight of the hydrocarbon-based polymer.
